(19) United States
(12) Patent Application Publication
(10) Pub. No.: US 2007/0008887 A1
(43) Pub. Date: Jan. 11, 2007

(54) Platform power management of a computing device using quality of service requirements of software tasks

(76) Inventors: Eugene Gorbatov, Hillsboro, OR (US); Richard A. Forand, Portland, OR (US); Paul Diefenbaugh, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/165,700

(22) Filed: Jun. 24, 2005

(51) Int. Cl. H04L 12/26

(52) U.S. Cl. 370/230

(57) ABSTRACT

Embodiments of the current invention describe a method of receiving quality of service (QoS) requirements for a software task of a computing device from an operating system QoS infrastructure and configuring a power management policy for a computing device using the QoS requirements for the software task of the computing device.

### BACKGROUND

1. Field

The present invention relates to the field of computer power management and the development of a power management policy for a computing device using the Quality of Service (QoS) requirements of software tasks.

2. Discussion of Related Art

Proliferation of ultra-mobile computing devices and their full-day usage requirements continue to place ever-increasing demands on battery life. Aggressive power management techniques have become an integral part of mobile platform design as form factors trend towards lighter and smaller devices while at the same time the rate of battery capacity growth has stalled. Power management policies have become quite complex in an attempt to deliver efficient power usage with minimal performance impact under a wide range of workloads behavior, but often fail to deliver optimal power efficiency given the wide variations, limited visibility, and other inherent constraints of purely predictive models.

Today's power management technologies provide the most benefit when both platform hardware devices and software (e.g. the operating system, applications, and drivers) behave in a known and predictable manner. However, platform power management policy is in large part unaware of software behavior, limiting the effectiveness of these mechanisms. As a result, platform power management policy either guesses at the behavior of the applications or takes a very conservative approach in power management to avoid problems.

### BRIEF DESCRIPTION OF THE DRAWINGS

FIG. 1 is flow chart of a method according to an embodiment of the present invention.

FIG. 2 is an illustration of a diagram that describes a relationship between the quality of service requirements of a software task and the power management of a computing device.

FIG. 3 is an illustration of an embodiment of an architecture for implementing software task QoS driven power management.

FIG. 4 is an illustration of exemplary software tasks containing QoS hints.

FIG. 5 is an illustration of an embodiment of a method of compiling power management policy.

FIG. 6 is an illustration of a computing system.

FIG. 7 is an illustration of a block diagram illustrating an embodiment of an architecture of a system including a QoS management module and a power policy module according to an embodiment of the present invention.

### DETAILED DESCRIPTION

Described herein are embodiments of methods, an apparatus, and a system that may establish a relationship between the Quality of Service (QoS) requirements of a software task and the power management behavior of platform hardware of a computing device. In the following description numerous specific details are set forth. One of ordinary skill in the art, however, will appreciate that these specific details are not necessary to practice embodiments of the invention. While certain exemplary embodiments of the invention are described and shown in the accompanying drawings, it is to be understood that such embodiments are merely illustrative and not restrictive of the current invention, and that this invention is not restricted to the specific constructions and arrangements shown and described because modifications may occur to those ordinarily skilled in the art. In other instances, well known semiconductor fabrication processes, techniques, materials, equipment, etc., have not been set forth in particular detail in order to not unnecessarily obscure embodiments of the present invention.

Embodiments of the current invention describe an approach for utilizing an operating system's Quality of Service (QoS) infrastructure to characterize and communicate software task-level QoS requirements for use by power management policies of a computing device with the goal of improving platform power efficiency. This approach establishes a relationship between the QoS requirements of a software task and the power management behavior of one or more hardware devices that the software task may utilize during its execution.

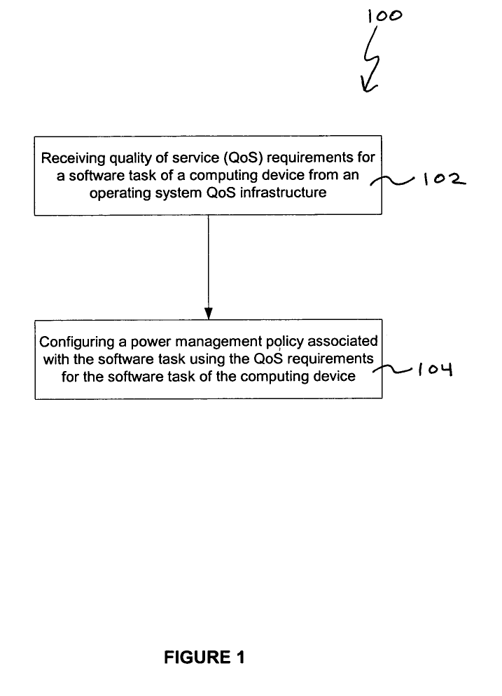

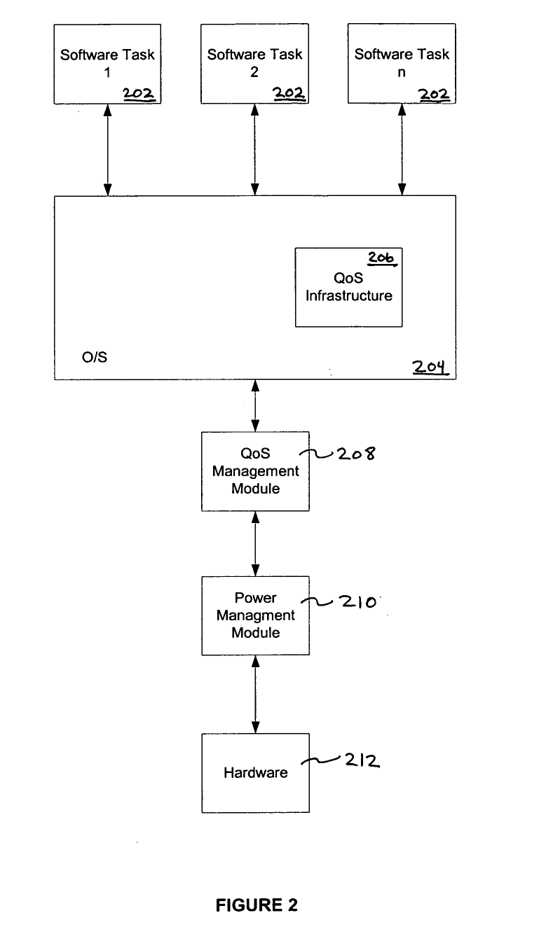

FIG. 1 is one embodiment of a flow-chart of a computer implemented method to establish the relationship between the QoS requirements of a software task and the platform power management policy. FIG. 2 illustrates a diagram of this same relationship. At block 102 a processor of a computing device receives QoS requirements for a software task 202 of a computing device from an operating system QoS infrastructure 206. The computing device may be a server, a desktop computer, a mobile device, a hand-held device, or any type of computing system where power management is important. In one particular embodiment the computing device may also be any type of device that is capable of wirelessly accessing a network including, for example, a laptop computer, a desktop computer, a palmtop computer, or tablet computer, a personal digital assistant, a pager, a cellular telephone. In one particular embodiment the computing device may be a laptop computer with a wireless communication module.

In an embodiment, the processor is coupled to a memory that stores QoS requirements for a software task of a computing device powered by a battery. The memory is in turn coupled to a QoS management module 208 to receive the QoS requirements for the software task 202 of the computing device from the operating system QoS infrastructure of the computing device having a battery power supply to power the processor and the memory. At block 104 a computing device power management policy is configured using the QoS requirements for the software task of the computing device having a battery power supply. In an embodiment, a power management module 210 is coupled to the QoS management module 208 to configure a power management policy using the QoS requirements for the software task 202 of the computing device.

FIG. 2 illustrates a diagram that describes how this relationship is established between the QoS requirements of a software task 202 of a computing device and computing device power management policy. There may be any number of software tasks 202 stored within the memory of the hardware 212 of the computing device. The software tasks 202 may be periodic workload applications that perform a certain amount of work per time, for example an MP3 player or a DVD player. The software tasks 202 may also be background applications that may be performed at any time, such as a virus scanner. In another embodiment, the software tasks 202 may be interactive applications that would need to respond quickly when a user is interacting with the application but otherwise may respond at any time. In yet another embodiment, the software tasks 202 may be a combination of any of periodic workload applications, background applications, and interactive applications. Other types of software tasks 202 than those listed herein may also be used. In an alternate embodiment, device drivers or OS services instead of applications may communicate QoS requirements to a power management module to instantiate a power management policy.

A software task may communicate quality of service requirements to the operating system (O/S) 204 to be collected by the QoS infrastructure 206 of the O/S 204. The QoS requirements are then passed from the QoS infrastructure to the QoS management module 208. The QoS management module 208 receives the QoS requirements for a software task 202 of a computing device from the operating system QoS infrastructure 206. The QoS management module 208 accepts the QoS requirements of the software tasks 202 to determine estimates of workload QoS requirements associated with the software tasks 202. The estimates of the workload QoS requirements are then sent to the power management module 210. The power management module 210 configures a power management policy using the workload QoS requirements received from the QoS management module 208. The power management module may then communicate the power management policy with the hardware 212. The power management policy may adapt the behavior of the hardware to software task requirements to optimize power savings of a computing device and to also keep the hardware within thermal limits.

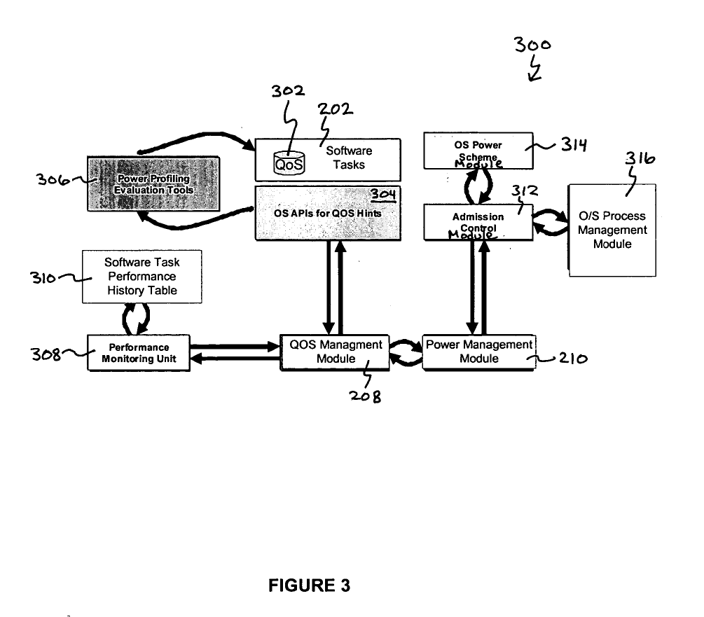

FIG. 3 illustrates one embodiment of an architecture 300 for implementing QoS driven power management. In this embodiment, the quality of service requirements of the software tasks 202 are specified through QoS hints 302. The QoS hints 302 provide details regarding the QoS requirements and workload behavior of a software task. The details provided by the QoS hints 302 may include among others software task scheduling preferences, performance requirements, Input-Output I/O or memory access patterns. The QoS hints may be static QoS hints, dynamic QoS hints, or a combination of static and dynamic QoS hints. Static QoS hints are hints that are preloaded into a software task 202 and dynamic QoS hints are hints that are dynamically created based on how a software task performs on a specific platform, e.g. a particular processor or chipset.

The static QoS hints 302 may be generated through many different tools by application and software developers. One such tool may be a software wizard, such as those present in Integrated Drive Electronics (IDEs) like Visual Studio. The software wizard may be augmented to include information about application performance requirements or access patterns. For example, an application developer may specify if the workload is periodic, how it intends to use the file system, and what are the processing requirements. The wizard may then generate the necessary application protocol interface (API) calls to provide QoS hints to the operating system at block 304. Compilers may also be used to analyze software code and insert QoS hints that convey to the Operating System (O/S) workload requirements and behavior. Additionally, performance evaluation and power profiling tools, such as Intel Corporation's Vtune™ may be used to profile applications and either generate or refine QoS hints to increase their accuracy.

Additionally, system-level performance monitoring unit 308 and performance history table 310 can be used to further refine or generate new QoS hints dynamically. The performance monitoring unit 308 may use Operating System (O/S) and hardware performance counters to monitor software task access patterns and resource usage and to derive dynamic QoS hints. The performance monitoring unit 308 may determine the software task QoS requirements dynamically at run time to improve the accuracy of QoS hints and to support software tasks that do not disclose QoS hints to the Operating System (O/S) system. The performance monitoring unit 308 may access various Operating System (O/S) and hardware counters such as the number of disk accesses or CPU utilization to derive QoS requirements for different workloads. It maintains a software task history table 310 that captures past workload behavior and that can be used to predict future activity patterns. For software tasks that provide static QoS hints, the activity monitor can be used to dynamically adjust or refine the QoS hints as workload executes.

The QoS management module 208 exposes an API that software tasks can use to provide hints. The hints are stored in the module and are used to generate process QoS requirements. Additionally, the QoS manager uses the performance monitoring unit 308 to provide workload behavior and requirements for software tasks that do not submit hints. As was mentioned above, QoS manager also uses performance information to refine the hints. QoS requirements are passed to the power management module 210. The power management module 210 integrates the QoS hints into its policy decisions. For example, QoS manager will provide details about software task requirements such as its expected network access pattern or required Operating System (O/S) tick frequency that the power management module 210 can use to develop the power management policy. The power management module 210 may also use the QoS requirements to characterize thermal parameters.

The admission control module 312 accepts user preferences for battery life from the Operating System (OS) power scheme module 314 and ensures that they can be met with the current system workload. The admission control module 312 queries the Operating System (O/S) process management module 316 and the QoS management module 208 to obtain an estimate for platform level power requirements of a current system workload and determines if the current battery level is sufficient to meet battery life expectations. When a new software task enters the system, the admission control module 312 evaluates the power requirements under the new workload and accepts the software task if it doesn't violate user battery life requirements. For example, if a virus scan requests to start, the admission control module 312 may deny the virus scan if the remaining battery capacity would be insufficient under the new system workload. In other embodiments, the admission control module 312 may also take thermal management policy into consideration in determining whether to accept a workload.

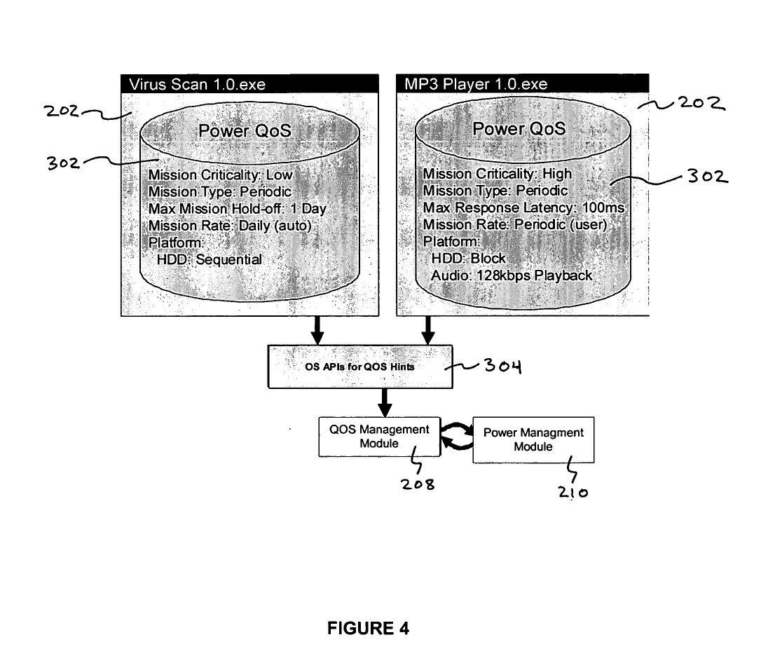

Examples of QoS hints 302 are illustrated in FIG. 4 for a virus scan application 202 and for an MP3 player application 202. These QoS hints 302 may be static hints, dynamic hints, or a combination of static and dynamic hints. These are examples of QoS hints 302 that are contained within the software tasks 202 supplied to the QoS infrastructure 206 and can then influence the power management policy in the platform/operating system. The QoS hints 302 may include, for example, the criticality of the mission of the application, the mission type of the software task 202 (e.g. periodic, interactive, or background), the maximum mission hold-off or latency, the mission rate, and details about the platform on which the software task 202 may run. These constraints are not necessarily static hints and may be updated by the feedback loop though the power profiling evaluation tools 306 as described above.

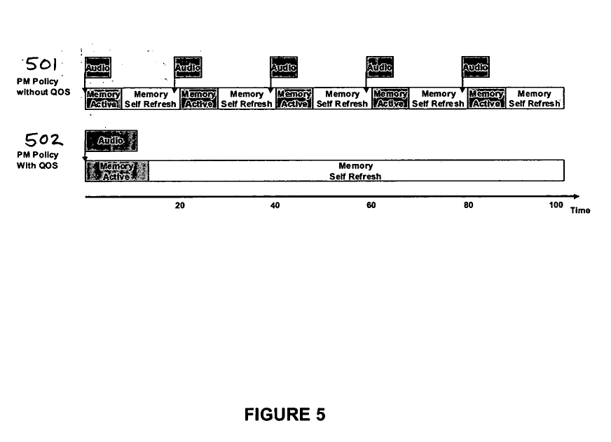

FIG. 5 illustrates one particular embodiment of configuring computing device power management policy using the QoS requirements for the software task 202. The software task 202 in this example is an MP3 player application. This software task 202 requires a certain amount of central processing unit (CPU) time and memory bandwidth and periodically accesses the hard drive to read ahead the MP3 content and uses an audio subsystem to output the audio stream of the MP3 player. As illustrated in FIG. 5, the power management (PM) policy that was formed without knowledge of the QoS requirements of the application is represented by the timeline 501. Without knowing the QoS requirements associated with the application, the audio subsystem assumes a very conservative audio transmission rate and limits the audio buffering to 20 milliseconds (ms). This may result in frequent CPU and memory activity and thus excessive power consumption. The timeline 502 represents an embodiment of the present invention where the enabling of the MP3 player to expose its QoS requirements and activity patterns to the power manager allows the power manager to configure a power management policy to adapt platform behavior to application requirements. In this example, the MP3 player application, as part of its QoS requirements, specifies that changes in audio stream (e.g. higher volume) need to be user-perceptible only within 100 ms. The power manager can then direct the audio subsystem driver stack to leverage large on-controller cache and to pre-fetch 100 ms worth of audio data at a time to significantly increase CPU C4 and memory self refresh residency and to thus reduce platform power consumption.

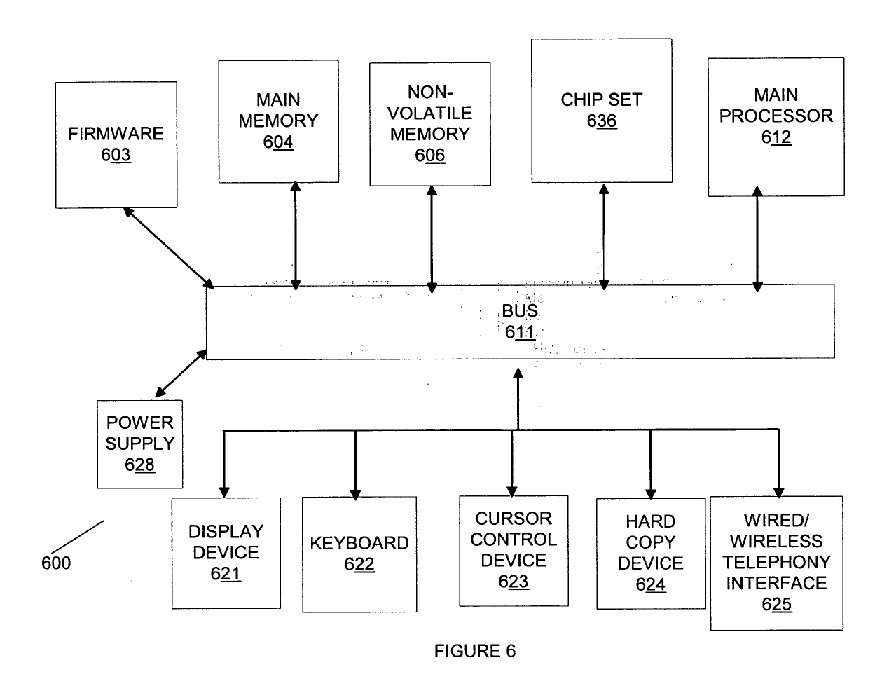

FIG. 6 illustrates a block diagram of an example computer system that may use an embodiment of the approach to establish a relationship between the quality of service requirements of a software task of a computing device and its power management policy. In one embodiment, computer system 600 comprises a communication mechanism or bus 611 for communicating information, and an integrated circuit component such as a processor 612 coupled with bus 611 for processing information. One or more of the components or devices in the computer system 600 such as the processor 612 or a chip set 636 may use an embodiment of the approach to establish a relationship between the quality of service requirements of a software task of a computing device and its power management infrastructure.

Computer system 600 further comprises a random access memory (RAM) or other dynamic storage device 604 (referred to as main memory) coupled to bus 611 for storing information and instructions to be executed by processor 612. Main memory 604 also may be used for storing temporary variables or other intermediate information during execution of instructions by processor 612.

Firmware 603 may be a combination of software and hardware, such as Electronically Programmable Read-Only Memory (EPROM) that has the operations for the routine recorded on the EPROM. The firmware 603 may embed foundation code, basic input/output system code (BIOS), or other similar code. The firmware 603 may make it possible for the computer system 600 to boot itself.

Computer system 600 also comprises a read-only memory (ROM) and/or other static storage device 606 coupled to bus 611 for storing static information and instructions for processor 612. The static storage device 606 may store OS level and application level software.

Computer system 600 may further be coupled to a display device 621, such as a cathode ray tube (CRT) or liquid crystal display (LCD), coupled to bus 611 for displaying information to a computer user. A chipset, such as chipset 636, may interface with the display device 621.

An alphanumeric input device (keyboard) 622, including alphanumeric and other keys, may also be coupled to bus 611 for communicating information and command selections to processor 612. An additional user input device is cursor control device 623, such as a mouse, trackball, trackpad, stylus, or cursor direction keys, coupled to bus 611 for communicating direction information and command selections to processor 612, and for controlling cursor movement on a display device 612. A chipset, such as chipset 636, may interface with the input output devices.

Another device that may be coupled to bus 611 is a hard copy device 624, which may be used for printing instructions, data, or other information on a medium such as paper, film, or similar types of media. Furthermore, a sound recording and playback device, such as a speaker and/or microphone (not shown) may optionally be coupled to bus 611 for audio interfacing with computer system 600. Another device that may be coupled to bus 611 is a wired/wireless communication interface 625.

Computer system 600 has a power supply 628 such as a battery, AC power plug connection and rectifier, etc.

In one embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

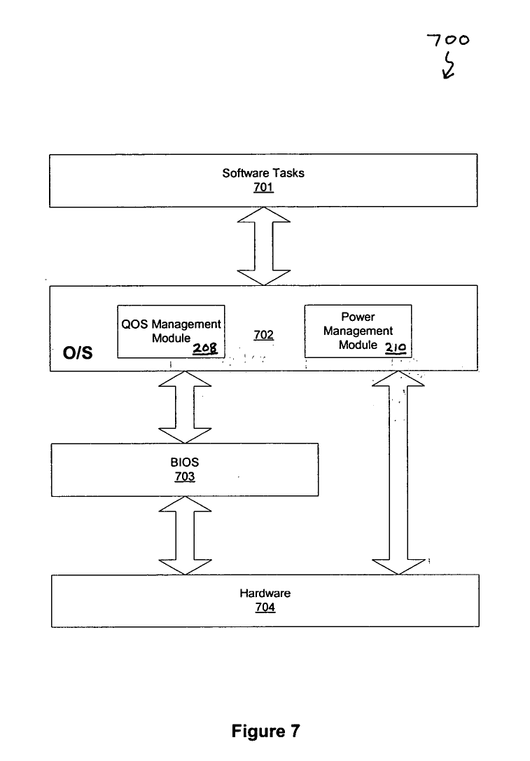

FIG. 7 is a block diagram illustrating an embodiment of an architecture, which may be used for implementing QoS driven power management. In one embodiment, exemplary architecture 700 includes, among others, applications 701, device drivers 702, BIOS 703, and hardware 704. Applications 701 may communicate with one or more device drivers 702 through an application programming interface (API) provided by the operating system (OS) or the device drivers. Device drivers 702 may access hardware (e.g., a processor) via BIOS 703 to program the hardware to perform certain operations. Alternatively, device drivers 702 may directly communicate with hardware 704 via a memory or 10 mapped interface.

Applications 701 may reside in a user space of the OS. A QoS management module 208 and a power management module 210 may reside in a kernel space of the OS 702, while BIOS 703 may reside in a firmware (e.g., ROM) within hardware 704. The OS 702 may be a Windows operating system from Microsoft Corporation. Alternatively, the OS may be a Mac OS from Apple Computer, Inc. Further, the OS may be a Unix or a Linux operating system. Other operating systems, such as a real-time operating system embedded in a set-top box type computer, may be utilized.

The QoS management module 208 may receive QoS requirements of the applications 701 from the applications 701 and communicate the QoS requirements to the power management module 210. The QoS management module 208 and the power management module 210 may reside in the OS 702, BIOS 703, or embedded in hardware 704.

Several embodiments of the invention have thus been described. However, those of ordinary skill in the art will recognize that the invention is not limited to the embodiments described, but can be practiced with modification and alteration within the scope and spirit of the appended claims that follow.

We claim:

1. A method, comprising:
receiving quality of service (QoS) requirements for a software task of a computing device from an operating system QoS infrastructure; and
configuring a power management policy for a computing device using the QoS requirements for the software task of the computing device.

2. The method of claim 1, wherein the QoS requirements for the software task further include QoS hints that define the workload and behavioral parameters of the QoS requirements.

3. The method of claim 1, further comprising determining whether a new work load can be accepted into the operating system without violating battery life expectations of a battery power supply of the computing device based on the computing device power management policy and the QoS requirements of the software task.

4. An apparatus, comprising:
a processor;
a memory coupled to the processor, the memory to store QoS requirements for a software task of a computing device;
a QoS management module coupled to the memory to receive QoS requirements for the software task resident on the computing device from an operating system QoS infrastructure of the computing device; and
a power management module coupled to the QoS management module to configure computing device power management policy using the QoS requirements for the software task of the computing device.

5. The apparatus of claim 4, further comprising a power profiling evaluation tool coupled to the QoS management module.

6. The apparatus of claim 4, wherein the memory further stores static QoS hints.

7. The apparatus of claim 4, further comprising a performance monitoring unit to generate dynamic QoS hints.

8. The apparatus of claim 4, further comprising a module to expose an API for QoS hints.

9. The apparatus of claim 4, further comprising a module to expose an Application Programming Interface (API) for QoS hints.

10. The apparatus of claim 4, wherein the apparatus is a laptop computer with a wireless communication module.

11. The apparatus of claim 4, further comprising an admission control module to accept the power management policy and to determine whether new workloads can be accepted without violating battery life expectations.

12. An apparatus, comprising:
a means for receiving QoS requirements for a software task of a computing device from an operating system QoS infrastructure; and
a means for configuring computing device power management policy using the QoS requirements for the software task of the computing device.

13. The apparatus of claim 12, further comprising a means for evaluating a power profile of a software task to generate dynamic QoS hints.

14. The apparatus of claim 12, further comprising a means for storing static QoS hints.

15. A system, comprising:
a processor;
a memory coupled to the processor to store instructions, which when executed from the memory causes the processor to receive QoS requirements for a software task of a computing device from an operating system QoS infrastructure and to configure computing device power management policy using the QoS requirements for the software task of the computing device; and
a battery to power the processor and the memory.

16. The system of claim 15, wherein the QoS requirements include static QoS hints.

17. The system of claim 15, wherein the QoS requirements include dynamic QoS hints.

18. A machine-readable medium having executable code to cause a computing device to perform a method for power management, comprising:
receiving quality of service (QoS) requirements for a software task of the device from an operating system QoS infrastructure; and
configuring a power management policy for a computing device using the QoS requirements for the software task of the computing device.

19. The machine-readable medium having executable code to cause the computing device to perform the method for power management of claim 18, further comprising determining whether new workloads can be accepted using an admission control module.

20. The machine-readable medium having executable code to cause the computing device to perform the method for power management of claim 18, wherein configuring the power management policy using the QoS requirements for the software task of the computing device further comprises configuring a thermal management policy using the QoS requirements associated with the software task.
